(19) United States
(12) Patent Application Publication
(10) Pub. No.: US 2010/0328248 A1
(43) Pub. Date: Dec. 30, 2010

(54) CAPACITIVE TOUCH SCREEN WITH REDUCED ELECTRODE TRACE RESISTANCE

(75) Inventor: Larry Stephen Mozdzyn, Garland, TX (US)

Correspondence Address: MARTIN & ASSOCIATES, LLC, P O BOX 548, CARTHAGE, MO, 64836-0548, US

(73) Assignee: OCULAR LCD INC., Richardson, TX (US)

(21) Appl. No.: 12/491,079

(22) Filed: Jun. 24, 2009

(51) Int. Cl. G06F 3/044; G06F 3/041

(52) U.S. Cl. 345/174; 345/173

(57) ABSTRACT

An improved touch screen has enhanced optical performance and aesthetic quality. The electrodes on the touch screen employ additional fine traces of conductive material to reduce the overall electrode trace resistance to increase electrical performance without sacrificing optical quality. The additional fine traces of conductive material may be placed on the top of the ITO traces or in channels inside the boundaries of the ITO traces. The additional traces preferably run the length of the ITO traces to reduce the resistance in the longer dimension. Further, the additional traces are very small in width such that in the aggregate they cover only a small portion of the ITO electrode trace in lateral dimension to reduce the visibility of the additional traces. The conductive material may also be formed as a plurality of geometric shapes substantially forming a line in the longer dimension of the transparent conductive traces to reduce the visibility of the conductive material.

### BACKGROUND

1. Technical Field

The disclosure and claims herein generally relate to touch screens, and more specifically relate to a touch screen with improved optical performance by adding additional conductive materials to reduce the resistance of the electrode traces.

2. Background Art

Touch screens have become an increasingly important input device. Touch screens use a variety of different touch detection mechanisms. One important type of touch screen is the capacitive touch screen. Capacitive touch screens are manufactured via a multi-step process. In a typical touch screen manufacturing process, a transparent conductive coating, such as indium tin oxide (ITO) is formed into conductive traces or electrodes on two surfaces of glass. The conductive traces on the two surfaces of glass typically form a grid that can sense the change in capacitance when a user's finger or a pointer touches the screen near an intersection of the grid. Thus the capacitive touch screen consists of an array of capacitors, where a capacitor is created at each crossing of the x and y conductive traces or electrodes which are separated by a dielectric. These capacitors are charged and discharged by scanning electronics. The scanning frequency of the touch screen is limited by a resistance/capacitive (RC) time constant that is characteristic of the capacitors. As the resistance of the trace becomes larger and larger, scanning times become proportionately longer and longer. Longer scan times are even more problematic as the panel sizes get larger. The larger the panel size the longer the traces and the higher the resistance gets.

In typical capacitive touch screens, the conductive traces or electrodes are formed with a layer of indium tin oxide (ITO). ITO is used because of its conductive and transparent qualities. The visibility of the electrode traces is distracting to the user. It is desirable for the touch screen to have the sense electrodes and other traces on the touch screen to be substantially invisible to the user, but it is also desirable to reduce the resistance of the traces to reduce the scan times and the performance of the touch screen. Increasing the thickness of the ITO layer can reduce the electrode trace resistance. However, increasing the thickness of the ITO layer sufficiently to decrease the electrode trace resistance results in reduced optical performance because the thicker ITO layer becomes more visible. Other conductive materials could be added to the electrode traces but the potential low resistance materials are opaque or reflective and have deleterious affects to the optical performance.

### BRIEF SUMMARY

The application and claims herein are directed to an improved touch screen with enhanced electrical performance and optical quality. The electrodes on the touch screen employ additional fine traces of conductive material to reduce the overall electrode trace resistance to increase electrical performance without sacrificing optical quality. The additional fine traces of conductive material may be placed on the top of the ITO traces or in channels inside the boundaries of the ITO traces. The additional traces run the length of the ITO traces to reduce the resistance in the longer dimension. Further, the additional traces are very small in width such that in the aggregate they cover only a small portion of the ITO electrode trace in lateral dimension to reduce the visibility of the additional traces. The conductive material may also be formed as a plurality of geometric shapes substantially forming a line in the longer dimension of the transparent conductive traces to reduce the visibility of the conductive material.

The description and examples herein are directed to capacitive touch screens with two substrates for the conductive sense electrodes, but the claims herein expressly extend to other arrangements including a single glass substrate.

The foregoing and other features and advantages will be apparent from the following more particular description, and as illustrated in the accompanying drawings.

### BRIEF DESCRIPTION OF DRAWINGS

The disclosure will be described in conjunction with the appended drawings, where like designations denote like elements, and:

FIG. 1 is a cross-sectional side view of a capacitive touch screen according to the prior art;

FIG. 2 is a cross-sectional side view of a capacitive touch screen as claimed herein;

FIG. 3 shows a top view of a portion of a conductive trace on the capacitive touch screen shown in FIG. 2;

FIG. 4 shows an enlarged view of a portion of the touch screen shown in FIG. 3;

FIG. 5 shows a portion of a touch screen with the low resistance conductors placed within the transparent conductive traces of ITO;

FIG. 6 shows a side view of the portion of the touch screen shown in FIG. 5;

FIG. 7 shows a side view of the portion of the touch screen in FIG. 6 with a resist layer before forming the low resistance conductors; and

FIG. 8 illustrates other examples of how the low resistance material can be formed on the electrodes.

### DETAILED DESCRIPTION

The description and claims herein are directed to an improved touch screen. The electrodes and other ITO traces on the touch screen employ additional fine traces of conductive material to reduce the overall electrode trace resistance to increase electrical performance without sacrificing optical quality. The additional fine traces of conductive material may be placed on the top of the ITO traces or in channels inside the boundaries of the ITO traces. The additional traces preferably run the length of the ITO traces to reduce the resistance in the longer dimension. Further, the additional traces are very small in width such that in the aggregate they cover only a small portion of the ITO electrode trace in lateral dimension to reduce the visibility of the additional traces.

The optical quality of a touch screen panel can be described in terms of transparency, where 100% transparent means 100% of the light transfers through the panel. A typical single layer of glass used in a touch screen panel has a transparency of about 97%. A typical optical adhesive has a transparency of about 99.5%. For a touch panel constructed out of two sheets of glass and a single layer of optical adhesive (No ITO on the glass at all), the overall transparency of the panel can be calculated as follows:

Total Panel transparency=0.97*0.97*0.995=93.6%

As described in the background, a typical touch screen panel has a layer of ITO on the glass to form electrodes for sensing the location where the screen is touched. The transparency of ITO coated glass with 100 ohm/square ITO is ˜92%. A touch panel constructed out of 100 ohm ITO glass with the optical adhesive is therefore about 0.92*0.92*0.995=85%. Other transparencies and thicknesses of ITO are summarized in Table 1.

TABLE 1

| ITO Thickness | Transparency of | Panel |
|---|---|---|
| (Ohms/square) | Glass with ITO (%) | Transparency |
| 15 | 87 | 75 |
| 100 | 92 | 85 |
| 200 | 94 | 90 |

With reference to Table 1, it can be seen that a higher resistance ITO layer (thinner layer) has a higher transparency. But as discussed above, it is advantageous to reduce ITO resistance for better performance. Thus there is a tradeoff between transparency for better optical performance and resistance of the ITO layer for better touch performance.

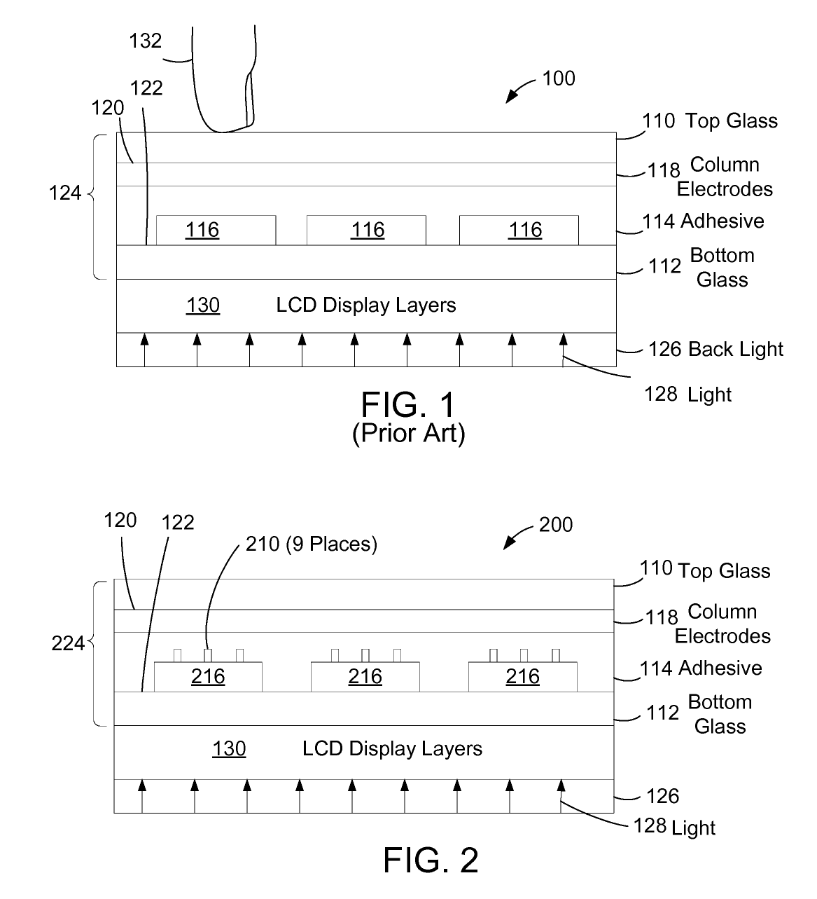

FIG. 1 shows a simplified side view of a capacitive touch screen 100 according to the prior art. The touch screen 100 has a top glass 110 and a bottom glass 112. The top glass 110 is bonded to the bottom glass 112 with a bonding layer or adhesive 114. Between the top glass and bottom glass there are row electrodes 116 and column electrodes 118. Only a single column electrode 118 is visible in this side view but there are multiple column electrodes such that the column electrode and the row electrodes form a grid in the manner known in the art. The column electrodes 118 are typically formed on the bottom surface 120 of the top glass 110 and the row electrodes 116 are formed on the top surface 122 of the bottom glass 112. The top glass 110 and bottom glass 112 attached by the adhesive layer 114 form a touch panel 124. Below the touch panel 124 is a back light 126 that provides light 128 to an LCD 130 that projects an image to the user through the touch panel 124. There may be a space (not shown) between the backlight 126 and the LCD 130. Sense electronics (not shown) connected to the row and column electrodes are able to determine the location of touch by a user's finger 132 in the manner known in the prior art.

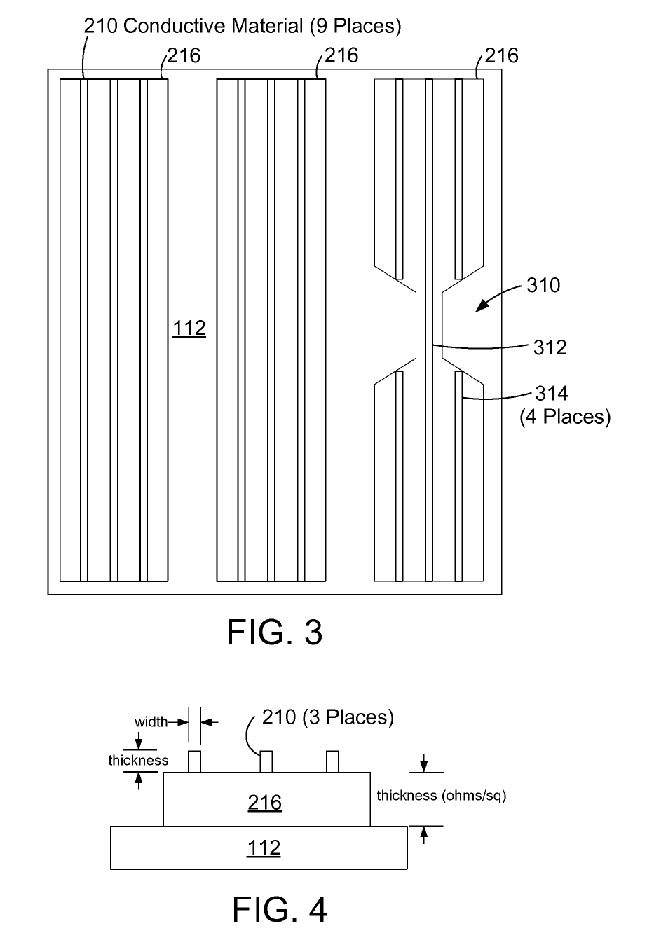

FIG. 2 illustrates a capacitive touch screen panel 200 as claimed herein. The touch screen panel 200 is similar to that shown in FIG. 1 with corresponding structures having the same number as described above. The touch screen panel 200 has additional opaque low resistance material conductors to reduce the trace resistance of the electrode traces as claimed herein. In the embodiment illustrated in FIG. 2, the row electrodes 216 have additional low resistance conductors 210 on top of the ITO row electrodes 216. The low resistance conductors 210 are electrically connected to the ITO so that they reduce the electrical resistance of the ITO electrodes such that they improve the performance of the touch panel 224 in the same manner as that achieved by increasing the ITO layer thickness as described above. In this embodiment, three low resistance conductors 210 are formed on the top of the ITO electrodes 216 and run the length of the row electrodes 216 as shown in FIG. 3.

Preferably, the low resistance conductors 210 shown in FIGS. 2 and 3 have a small line geometry or trace width such that they are undetectable with the naked eye. The line geometries of the resistance conductors are preferably less than 0.05 mm in width and most preferably less than 0.02 mm. Further, the overall percentage of area of the ITO trace that is covered by the low resistance material is substantially small compared to the width of the ITO trace so the overall transparency of the ITO is relatively unchanged. Preferably the low resistance material is narrower in width than the ITO trace such that the percentage of the ITO covered by the low resistance material is less than 15% and more preferably 5% or less. The thickness of the low resistance material is not critical. A thicker low resistance material will lower the resistance of the trace and improve performance as described above so a thicker low resistance material is preferable. The opaque low resistance conductors could be made from any suitable low resistance material that has a resistivity that is much lower than ITO (preferably less than 1 ohms/sq or more preferably less than 0.2 ohms/sq) such as nickel, copper, gold, silver or aluminum. The low resistance conductors could also be formed with a random pattern to reduce visibility as described further below. The low resistance material may be formed using methods such as pattern electrode plating, pattern electroless plating, plating followed by an etching process, thin film deposition followed by photo etching, or an other suitable method to produce the structures described herein.

In capacitive touch panels there are different methodologies to measure the capacitive coupling effect when the panel is touched. Some methods use a separate sense line to sense the change in capacitance while the electrodes are being driven by the controller. In other methods, the electrodes are constantly being switched such that one electrode is driven and another electrode is used as the “sense” line. The touch panel described above does not show separate sense line. However, the low resistance material described herein can be used to reduce the resistance of touch panel structures, including sense lines and electrodes. The claims herein extend to any of these touch panel technologies whether using a separate sense line or electrodes that are doing double duty as electrodes and sense lines.

Again referring to FIG. 3, an electrode with a reduced neck area 310 is illustrated. Some touch screens use an electrode with a reduced neck area 310 to reduce the capacitance between the electrode with the reduced neck area and another perpendicular electrode. The column electrode 118 (shown in FIG. 2 and running perpendicular to the electrode shown) may also have a reduced neck area as known in the prior art. As described herein, the electrodes have one or more low resistance conductors 210. Where the touch screen utilizes an electrode with a reduced neck area 310, the low resistance conductors 210 may or may not extend through the low neck area 310. Preferably, one or more low resistance conductors 312 that will fit on the electrode in the reduced neck area 310 continue through the reduced neck area while the remaining low resistance conductors 314 stop short at the reduced neck area as shown. The low resistance conductors “fit” on the reduced neck area when the spacing is within the spacing described above such that it does not make the low resistance conductors appreciably visible to the user.

FIG. 4 illustrates an enlarged view of an ITO electrode 216 shown in FIGS. 2 and 3. The ITO electrode 216 includes three opaque low resistance conductors 210 added on top of the ITO 112. We will consider how the added low resistance conductors affect the resistance and optical clarity of the panel in this example. We will assume the ITO trace 216 is 2 mm wide and 200 mm in length. These dimensions give a total trace resistance depending on the thickness of the trace (ohms/sq) as follows:

200 ohm/sq ITO: trace resistance=200*200/2=20K ohm

100 ohm/sq ITO: trace resistance=100*200/2=10K ohm

30 ohm/sq ITO: trace resistance=30*200/2=6K ohm

15 ohm/sq ITO: trace resistance=15*200/2=3K ohm

In this example, we assume the low resistance conductors 210 are 0.025 mm wide by 200 mm long by 0.001 mm thick nickel conductors on top of a the 100 ohm/sq ITO trace that is 200 mm*2 mm in size. The electrical circuit equivalence is four resistors in parallel. All of the nickel conductors are of equal resistance. The resistor values are calculated as follows:
a. ITO trace: 200 ohm/sq ITO: trace resistance=100*200/2=20K ohm
b. Nickel trace: R=1*p/A where 1 is the trace length, p is the nickel resistivity in ohm*mm and A is the cross sectional area of the conductor in mm² R=200*15*10^{-5/}(0.025*0.001)=1200 ohms
c. Using the parallel resistor calculation the overall trace resistance for the four conductors (20 k, 1200, 1200, 1200)=390 ohms. Thus the resistance of the ITO trace 216 is effectively lowered from 20K ohms to 390 ohms.

Again referring to the example shown in FIG. 4, the equivalent transparency of the glass sheet with the added nickel traces is a ratio of the ITO area to the nickel area. The three nickel traces cover 3.8% of the ITO trace thus reducing the trace transparency of the glass with ITO by 3.8%. This would be an effective transparency of about 90% for the trace areas of the glass (from 94% to about 90%). Additionally the ITO traces typically occupy only about 30% of the total area of the panel. In the non-trace area of the panel the transparency would remain at the 200 ohm/sq value of 94%. Thus, the overall effective transparency to the single sheet of glass would be 0.94*0.7+0.90*0.3=93%. This would result in an overall panel transparency of 0.93*0.93*0.995=86% (two sheets of glass and adhesive). Thus our example panel of 200 ohm ITO glass would have about the same effective optical transparency of a panel made with 100 ohm ITO glass but the effective trace resistance would be 25 times lower that the typical 100 ohm ITO glass, which will significantly increase performance of the touch screen panel.

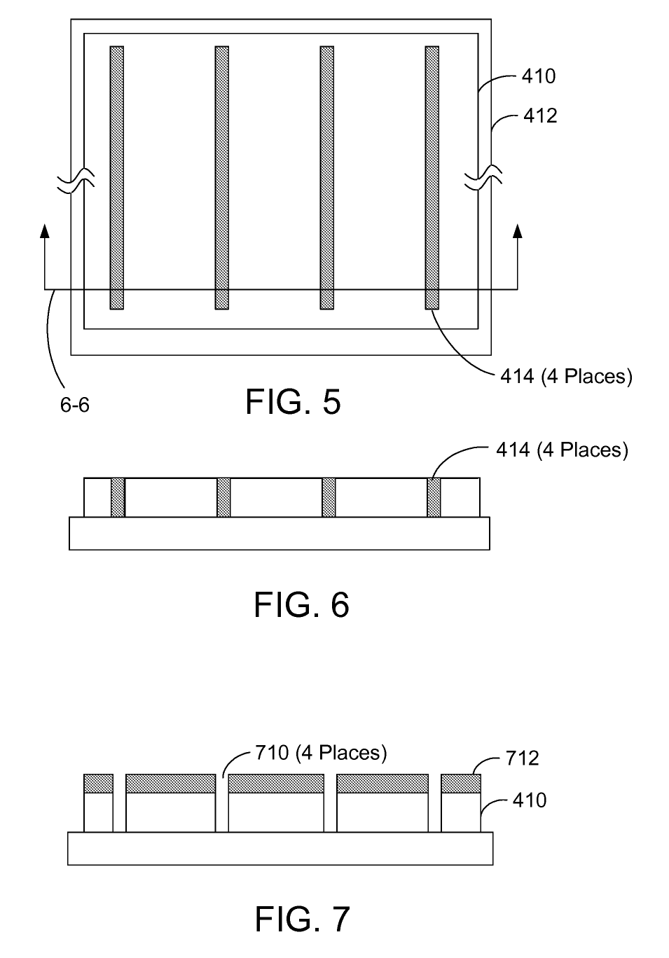

FIGS. 5 through 7 illustrate another example. FIG. 5 illustrates a top view of a single ITO trace 410 on a glass surface 412. The ITO trace 410 is similar to ITO traces 216 in FIGS. 2 through 4. In this example, low resistance conductors 414 are placed within the ITO trace 410 rather than on top of the ITO traces as described previously. FIG. 6 is a cross sectional view of the ITO trace as taken along the lines 6-6 in FIG. 5. FIG. 6 more clearly illustrates how the low resistance conductors 414 are embedded inside the ITO traces 410 such that the low resistance conductors are surrounded by the ITO except on the top surface 610 of the low resistance conductors 414. FIG. 7 illustrates the same cross section as FIG. 6 with the resist pattern 712 formed on the ITO trace 410 used to form the ITO layer. FIG. 7 shows how the openings 710 for depositing the low resistance conductors 414 (shown in FIG. 6) into the ITO traces 410 may be formed with the same resist pattern 712 used to form the ITO trace 410. After depositing the low resistance conductors 414 and removing the resist pattern 712 shown in FIG. 7, the ITO traces 410 appear as shown in FIG. 6.

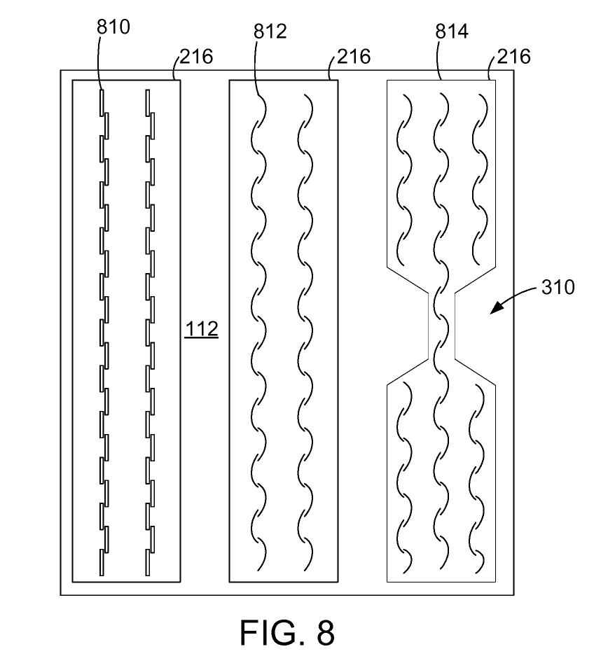

FIG. 8 illustrates other examples of how the low resistance material can be formed on the electrodes. In addition to the straight line example described above, the low resistance material or conductors may be formed in other shapes to reduce the visibility to the user. The shapes are made to form a nearly linear pattern lengthwise in the longer dimension of the ITO conductor 216 to reduce the resistance of the ITO conductor in the longer dimension on the touch screen. In the first example, the low resistance material is formed into two adjacent lines of rectangles or two adjacent lines of line segments 810. The rectangles or line segments 810 may touch each other as shown, or they may be separated. In the second example, the low resistance material is formed into a series of curved lines or arcs 812. In this example, the curved lines 812 overlap but do not touch each other. Similarly, the curved lines could touch each other or not overlap. Many other geometric shapes could be used to pattern the low resistance material to reduce the visibility of the conductive material formed on the ITO layer, where the conductive material is formed of a plurality of geometric shapes substantially forming a line in the longer dimension of the transparent conductive traces. The third example in FIG. 8 uses curved lines 814 as described above on an ITO electrode 216 with a reduced neck area 310.

One skilled in the art will appreciate that many variations are possible within the scope of the claims. Thus, while the disclosure has been particularly shown and described above, it will be understood by those skilled in the art that these and other changes in form and details may be made therein without departing from the spirit and scope of the claims.

1. A touch screen comprising:
a plurality of transparent conductive traces formed on a transparent material;
a plurality of opaque low resistance conductors electrically connected to the transparent conductive traces along a length of the transparent conductive traces; and
wherein the plurality of opaque low resistance conductors are substantially narrower than the transparent conductive traces such that the plurality of opaque low resistance conductors cover less than fifteen percent of the width of the transparent conductive traces.

2. The touch screen of claim 1 wherein the opaque low resistance conductors are on a top surface of the transparent conductive traces.

3. The touch screen of claim 1 wherein the opaque low resistance conductors are embedded inside the transparent conductive traces.

4. The touch screen of claim 1 wherein the plurality of transparent conductive traces are formed of indium tin oxide (ITO).

5. The touch screen of claim 1 wherein the touch screen is a capacitive touch screen and the conductive traces are formed on a glass surface.

6. The touch screen of claim 1 wherein the transparent conductive traces comprise sense lines.

7. The touch screen of claim 1 wherein the plurality of opaque low resistance conductors comprise a plurality of geometric shapes substantially forming a line in the longer dimension of the transparent conductive traces.

8. The touch screen of claim 7 wherein the plurality of geometric shapes are chosen from the following: two adjacent lines of rectangles and overlapping curved lines.

9. A capacitive touch screen comprising:
a plurality of transparent conductive traces formed on a transparent material;
a plurality of opaque low resistance conductors electrically connected to the transparent conductive traces along a length of the transparent conductive traces; and
wherein the plurality of opaque low resistance conductors are substantially narrower than the transparent conductive traces such that the plurality of opaque low resistance conductors cover less than five percent of the width of the transparent conductive traces.

10. The touch screen of claim 9 wherein the opaque low resistance conductors are on a top surface of the transparent conductive traces.

11. The touch screen of claim 9 wherein the opaque low resistance conductors are embedded inside the transparent conductive traces.

12. The touch screen of claim 9 wherein the plurality of transparent conductive traces are formed of indium tin oxide (ITO).

13. The touch screen of claim 9 wherein the transparent conductive traces comprise sense lines.

14. The touch screen of claim 13 wherein the plurality of opaque low resistance conductors comprise a plurality of geometric shapes substantially forming a line in the longer dimension of the transparent conductive traces.

15. A capacitive touch screen comprising:
a plurality of transparent conductive traces formed of indium tin oxide (ITO) on a transparent glass material;
a plurality of metal conductors electrically connected to the transparent conductive traces along a length of the transparent conductive traces; and
wherein the plurality of metal conductors are substantially narrower than the transparent conductive traces such that the plurality of low resistance conductors cover less than five percent of the width of the transparent conductive traces.

16. The touch screen of claim 15 wherein the metal conductors are on a top surface of the transparent conductive traces.

17. The touch screen of claim 15 wherein the metal conductors are embedded inside the transparent conductive traces.

18. The touch screen of claim 15 wherein the transparent conductive traces comprise sense lines.

19. The touch screen of claim 15 wherein the plurality of metal conductors comprise a plurality of geometric shapes substantially forming a line in the longer dimension of the transparent conductive traces.

20. The touch screen of claim 19 wherein the plurality of geometric shapes are chosen from the following: two adjacent lines of rectangles and overlapping curved lines.
